(19) United States
(12) Patent Application Publication
(10) Pub. No.: US 2025/0289220 A1
(43) Pub. Date: Sep. 18, 2025

(54) LIQUID EJECTION HEAD AND LIQUID EJECTION APPARATUS

(71) Applicant: CANON KABUSHIKI KAISHA, Tokyo (JP)

(72) Inventors: SHIN ISHIMATSU, Kanagawa (JP); SHIMPEI YOSHIKAWA, Kanagawa (JP); TAKEHO MIYASHITA, Kanagawa (JP); KYOSUKE TODA, Kanagawa (JP); RYO SATO, Tokyo (JP); HIROKI TAJIMA, Kanagawa (JP); TATSUKI SASAKI, Kanagawa (JP); SATOSHI IDETA, Kanagawa (JP); YUJI TAMARU, Tokyo (JP); YOSUKE TAKAGI, Kanagawa (JP); YASUAKI KITAYAMA, Kanagawa (JP)

(21) Appl. No.: 19/076,857

(22) Filed: Mar. 11, 2025

(30) Foreign Application Priority Data
Mar. 13, 2024 (JP) 2024-038809

(51) Int. Cl. B41J 2/14

(52) U.S. Cl. CPC B41J 2/14072; B41J 2002/14491

(57) ABSTRACT

A liquid ejection head includes an element substrate configured to include an element, which is driven by a drive signal, and an ejection opening for ejecting liquid by driving of the element, a flexible circuit board configured to include wiring for supplying the drive signal to the element, and a support member configured to support the element substrate and the flexible circuit board via a surface of the support member, wherein the flexible circuit board has a bending portion bent along one side of the support member extending in a first direction, and wherein in the bending portion, the wiring is absent in a region facing a side of the element substrate in a second direction orthogonal to the first direction when viewed from a direction perpendicular to the surface of the support member.

### BACKGROUND

### Field

The present disclosure relates to a liquid ejection head and a liquid ejection apparatus.

### Description of the Related Art

A liquid ejection head for use in a liquid ejection apparatus, such as an inkjet recording apparatus, drives an energy generation element based on electric signals from the main body of the apparatus to eject liquid droplets from minute ejection openings. The liquid ejection head mounted on the recording apparatus main body is controlled and driven by electric signals supplied from the recording apparatus main body and ejects liquid to a medium to form an image or the like. Thus, the liquid ejection head includes an electric circuit board for transmitting a drive signal and the like. In general, the liquid ejection head includes an element substrate including energy generation elements and ejection openings, and a flexible circuit board serving as an electric circuit board electrically connected to the element substrate.

The electric circuit board includes an electric signal input part including a conductive contact pad, and the recording apparatus main body includes a contact pin that electrically connects to the contact pad. Electrical communication becomes enabled when the contact pad and the contact pin come into contact.

In recent years, liquid ejection apparatuses and liquid ejection heads have been required to produce a high-definition image at high speed and at low cost. Thus, energy generation elements are highly integrated in the element substrate, which leads to increase in the number of wires in the flexible electric circuit board (flexible board).

Methods of accommodating the increased number of wires includes a method of increasing the width and the length of the flexible circuit board. In this case, the flexible circuit board which is large in size is bent and fixed along a housing of a liquid ejection head, whereby an increase in the size of the liquid ejection head is avoided.

Japanese Patent Application Laid-Open No. 2015-93452 discloses a configuration in which a flexible circuit board electrically connected to an element substrate is bent and fixed to a surface of a housing of a liquid ejection head.

Regarding the bending of the flexible circuit board, from the viewpoint of suppressing increase in paper pressing width to reduce the amount of cockling of the ejection receiving medium, such as a sheet, in a region where liquid is ejected, it is desirable to bend the flexible circuit board at a curvature close to a right angle. This is because increase in paper pressing width leads to increase in size of the recording apparatus main body, which also leads to an increase in cost. On the other hand, in a case where the bend curvature of the flexible circuit board is small, wiring inside the flexible circuit board may be broken at the bending portion.

### SUMMARY

The present disclosure for addressing the above-described issues is directed to obtaining a liquid ejection head in which electrical reliability of wiring in a bending portion of a flexible circuit board is improved.

According to some embodiments of the present disclosure, a liquid ejection head includes an element substrate configured to include an element, which is driven by a drive signal, and an ejection opening for ejecting liquid by driving of the element, a flexible circuit board configured to include wiring for supplying the drive signal to the element, and a support member configured to support the element substrate and the flexible circuit board via a surface of the support member, wherein the flexible circuit board has a bending portion bent along one side of the support member extending in a first direction, and wherein in the bending portion, the wiring is absent in a region facing a side of the element substrate in a second direction orthogonal to the first direction when viewed from a direction perpendicular to the surface of the support member.

According to another aspect of the present disclosure, a liquid ejection head includes an element substrate configured to include an element, which is driven by a drive signal, an ejection opening for ejecting liquid by driving of the element, and a terminal for receiving the drive signal externally, a flexible circuit board configured to include wiring for supplying the drive signal to the element, and a support member configured to support the element substrate and the flexible circuit board via a surface of the support member, wherein the flexible circuit board has a bending portion bent along one end of the support member extending in a first direction, and wherein the bending portion has an opening including a region facing a side of the element substrate in a second direction orthogonal to the first direction when viewed from a direction perpendicular to the surface of the support member.

Further features of the present disclosure will become apparent from the following description of exemplary embodiments (with reference to the attached drawings).

### BRIEF DESCRIPTION OF THE DRAWINGS

FIG. 1A is a schematic configuration diagram illustrating an example of a liquid ejection apparatus, and FIG. 1B is a control block diagram.

FIG. 2 is an exploded perspective view illustrating an example of a liquid ejection head.

FIGS. 3A and 3B are schematic perspective views illustrating an example of the liquid ejection head.

FIG. 4 is a schematic diagram illustrating an example of an ejection unit.

FIG. 5 is a schematic diagram illustrating an ejection unit of a comparative example.

FIGS. 6A and 6B are cross-sectional views illustrating the ejection unit of the comparative example.

FIG. 7 is a cross-sectional view illustrating the ejection unit of the comparative example.

FIG. 8 is a schematic view illustrating an ejection unit according to a first exemplary embodiment.

FIG. 9 is a schematic view illustrating the ejection unit according to the first exemplary embodiment.

FIG. 10 is a cross-sectional view illustrating the ejection unit according to the first exemplary embodiment.

FIG. 11 is a schematic view illustrating an ejection unit according to a second exemplary embodiment.

FIG. 12 is a cross-sectional view illustrating the ejection unit according to the second exemplary embodiment.

FIG. 13 is a schematic view illustrating an ejection unit according to a third exemplary embodiment.

FIG. 14 is a schematic view illustrating an ejection unit according to a fourth exemplary embodiment.

FIG. 15A is a schematic view illustrating an ejection unit according to a fifth exemplary embodiment, and FIG. 15B is a cross-sectional view illustrating the ejection unit according to the fifth exemplary embodiment.

FIG. 16 is a schematic view illustrating an ejection unit of another comparative example.

FIG. 17 is a schematic view illustrating an ejection unit according to a sixth exemplary embodiment.

### DESCRIPTION OF THE EMBODIMENTS

Hereinafter, various exemplary embodiments, features, and aspects of the present disclosure will be described with reference to the drawings. The following description does not limit the scope of the present disclosure. As an example, in the present exemplary embodiments, a thermal method in which a bubble is generated by a heating element to eject liquid is employed. The present disclosure is also applicable to a liquid ejection head that employs a piezoelectric method using a piezoelectric element as an energy generation element for ejecting liquid, or other various liquid ejecting methods. A liquid ejection head and a liquid ejection apparatus equipped with the liquid ejection head according to the present disclosure are applicable to apparatuses, such as an inkjet printer, a copier, a facsimile machine including a communication system, and a word processor including a printer unit. Further, the present disclosure is applicable to an industrial recording apparatus in which various processing apparatuses are combined in a complex manner. For example, the liquid ejection head and the liquid ejection apparatus equipped with the liquid ejection head according to the present disclosure are also applicable in, for example, biochip production, electronic circuit printing, and semiconductor substrate production.

While the present exemplary embodiments are described using a liquid ejection apparatus in which liquid, such as ink, is circulated between a tank provided in a liquid ejection head and the liquid ejection head, other forms may be adopted. For example, the liquid may be circulated between the tank provided outside the liquid ejection head and the liquid ejection head. Alternatively, two tanks are disposed upstream and downstream of the liquid ejection head, and the liquid in the pressure chamber is caused to flow by a flow of the liquid from one tank to the other tank without circulating the liquid.

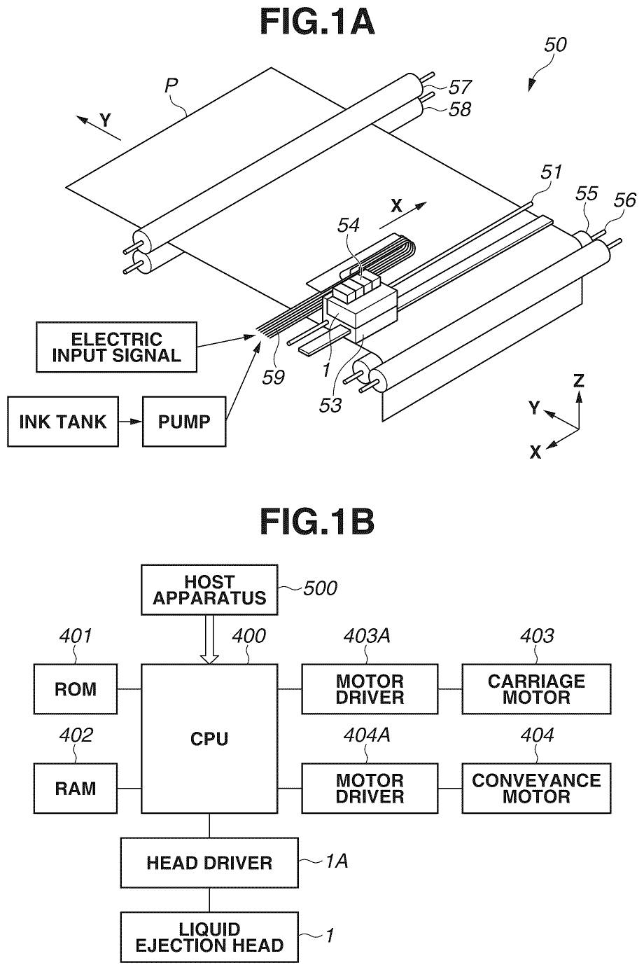

A first exemplary embodiment will be described. FIG. 1A is a schematic perspective view illustrating a configuration example of a liquid ejection apparatus 50 using a liquid ejection head 1 to which the present disclosure is applicable, and FIG. 1B is a block diagram illustrating a control system of the liquid ejection apparatus 50.

The liquid ejection apparatus 50 in FIG. 1A is a serial scanning type ink jet printer in which the liquid ejection head 1 ejects ink while performing a scanning motion to record an image or the like on a medium P. The liquid ejection head 1 is mounted on a carriage 53, and the carriage 53 moves along a guide shaft 51 in a main scanning direction indicated by an arrow X. The medium P is conveyed in a sub-scanning direction indicated by an arrow Y intersecting (orthogonal in the present exemplary embodiment) the main scanning direction by conveyance rollers 55, 56, 57, and 58. In FIG. 1A, an X direction is a scanning direction of the carriage 53 and is a width direction of the medium P, a Y direction is a conveyance direction of the medium P, and a Z direction is a direction intersecting the X direction and the Y direction and is the direction opposite to a direction in which liquid is ejected. A circulation unit 54 is mounted on the liquid ejection head 1, and ink circulation in an ejection unit 300 described below is performed. An ejection element (described below) included in the ejection unit 300 is driven by a head driver 1A in accordance with an input signal from an electric connection board. A signal to be used for ejection and ink and air are supplied to the carriage 53 via electric wiring and piping by a guide 59.

A central processing unit (CPU) (control unit) 400 controls the liquid ejection apparatus 50, based on programs of a processing procedures or the like, which are stored in a read-only memory (ROM) 401, and a random-access memory (RAM) 402 is used as a working area or the like for execution of the processing. The CPU 400 may include one or more processors and controls the head driver 1A based on image data from a host apparatus 500 disposed outside the liquid ejection apparatus 50. The CPU 400 controls a carriage motor 403 for moving the carriage 53 via a motor driver 403A and controls a conveyance motor 404 for conveying the medium P via a motor driver 404A.

The liquid ejection head 1 illustrated in FIG. 1A is configured for full-color printing with cyan, magenta, yellow, and black (CMYK) inks. The liquids to be ejected from the liquid ejection head 1 is not limited to these, and the liquid ejection head 1 may be configured to eject a reaction liquid or the like as a white ink, or may be configured to eject a black ink alone. A cap member (not illustrated) is disposed in a position off a conveyance path of the medium P, and when a liquid ejection operation is not performed, the cap member relatively moves to a position in which the cap member covers a face surface of the liquid ejection head 1, and performs a suction operation for filling or recovering to prevent the ejection openings from drying.

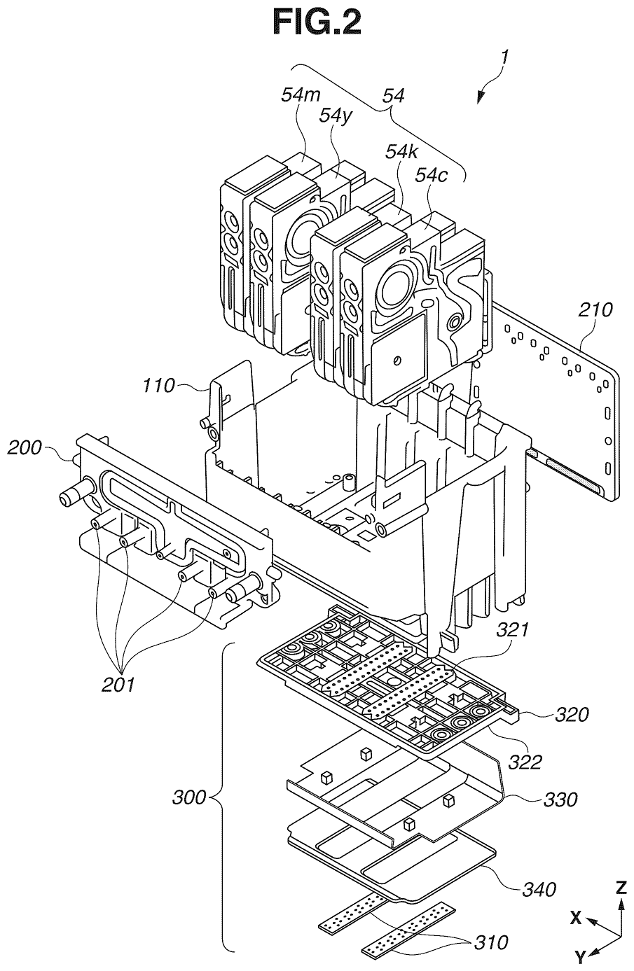

FIG. 2 is an exploded perspective view illustrating the liquid ejection head 1 of the present exemplary embodiment. As illustrated in FIG. 2 and FIG. 1A, the liquid ejection head 1 includes the circulation unit 54. The circulation unit 54 includes circulation units each corresponding to a different type of liquid (ink, reaction liquid, or the like) to be discharged. In the present exemplary embodiment, circulation units 54m, 54y, 54k, and 54c corresponding to the magenta ink, the yellow ink, the black ink and the cyan ink, respectively, are disposed. Each of the circulation units 54m, 54y, 54k, and 54c is connected to a flow path member 110 which is a housing of the liquid ejection head 1. As a method of the connection between the circulation unit 54 and the flow path member 110, any connection method, such as a screw fastening method in which a sealing member is interposed between the circulation unit 54 and the flow path member 110 or a connection method using welding, is usable. The flow path member 110 includes a connection member 200 having supply openings for receiving ink from the apparatus main body, and the connection member 200 communicates with the circulation unit 54 (each of the circulation units 54m, 54y, 54k, and 54c).

In a state where the liquid ejection head 1 is mounted on the apparatus main body, supply tubes (not illustrated) each corresponding to a different type of liquid (ink) to be ejected are connected to ink supply openings 201 of the connection member 200. The supply tubes are disposed in a guide 59 illustrated in FIG. 1A. The inks supplied via the supply tubes are each supplied to the corresponding one of the circulation units 54m, 54y, 54k, and 54c via the connection member 200 of the flow path member 110. The ejection unit 300 is connected to a bottom surface (a surface in the −Z direction) of the flow path member 110, and the ink supplied to the circulation unit 54 is supplied to the ejection unit 300 via the flow path member 110.

As a method of the connection between the ejection unit 300 and the flow path member 110, any method is usable, and the ejection unit 300 and the flow path member 110 may be bonded to each other using an adhesive or may be fixed to each other by screwing with a sealing member interposed therebetween. The ejection unit 300 includes ejection openings from which the inks are ejected, element substrates 310 including an ejection element for ejecting the inks, a flexible circuit board 330 for transmitting electric signals to the element substrates 310, a support member 320 for supporting the element substrates 310 and the flexible circuit board 330, and a cover member 340 for covering the flexible circuit board 330. The element substrates 310 and the flexible circuit board 330 are bonded and fixed to a first surface 322 of the support member 320.

The cover member 340 is bonded to cover surfaces of the element substrates 310 on which the ejection openings are disposed. The cover member 340 has openings each in a position corresponding to the corresponding one of the element substrates 310. The support member 320 serves also as a flow path member having flow paths 321 each via which the corresponding ink is supplied from the circulation unit 54 to the corresponding element substrate 310.

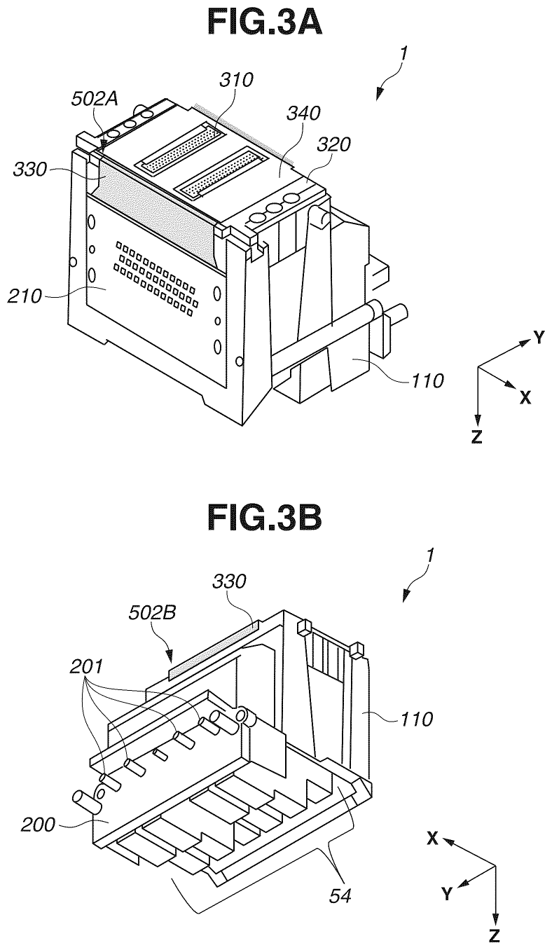

FIG. 3A is a schematic perspective view illustrating the liquid ejection head 1 of the present exemplary embodiment as viewed from an electric circuit board 210, and FIG. 3B is a schematic perspective view of the liquid ejection head 1 as viewed from the connection member 200. As illustrated in FIGS. 3A and 3B, the flexible circuit board 330 is bonded to a surface of the support member 320 that supports the element substrates 310. The flexible circuit board 330 is disposed to the flow path member 110 serving as the housing, with a bending portion 502A disposed on the side with the electric circuit board 210 of the support member 320 and a bending portion 502B disposed on the side with the connection member 200 of the support member 320. In the present specification, the “bending portions” of the flexible circuit board each refer to a portion of the flexible circuit board 330 which is bent to have a curved surface shape.

In the bonding and fixing of the flexible circuit board 330, the flexible circuit board 330 is also disposed on two surfaces of the support member 320 both of which are surfaces where the element substrates 310 are not bonded. In the disposing, as illustrated in FIG. 2, the flexible circuit board 330 may be bent along the sides of the support member 320 and then bonded to the support member 320. A part of the flexible circuit board 330 may be bonded to the support member 320 and then bent along the support member 320. The flexible circuit board 330 may be bent along the support member 320 after bonding of the cover member 340. Alternatively, the cover member 340 may be omitted. Yet alternatively, unlike the configuration illustrated in FIG. 2, a configuration in which the cover member 340 is bonded to the support member 320, and the flexible circuit board 330 is bonded on the cover member 340 and bent may be adopted.

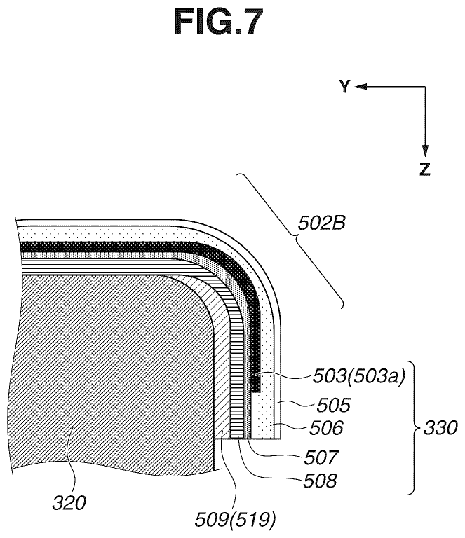

In order to strengthen the bonding force and prevent decrease in reliability due to ink penetration, an adhesive or a sealant 519 which is a resin member is inserted into a space 509 between the support member 320 and the flexible circuit board 330 (see FIG. 7).

A surface of the flow path member 110 which is a surface opposite to a surface on which the connection member 200 is disposed is a contact surface to which the electric circuit board 210 that receives electric signals from the apparatus main body is connected. Electric signals are transmitted from the electric circuit board 210 to the element substrates 310 via the flexible circuit board 330. Any method of, for example, crimping, fixing with an adhesive, or fixing with a double-sided tape, may be used for connection of the electric circuit board 210 to the flow path member 110. While the electric connection between the electric circuit board 210 and the flexible circuit board 330 is formed by anisotropic conductive film (ACF) pressure bonding in the present exemplary embodiment, wire bonding, flying lead bonding, or the like may be used.

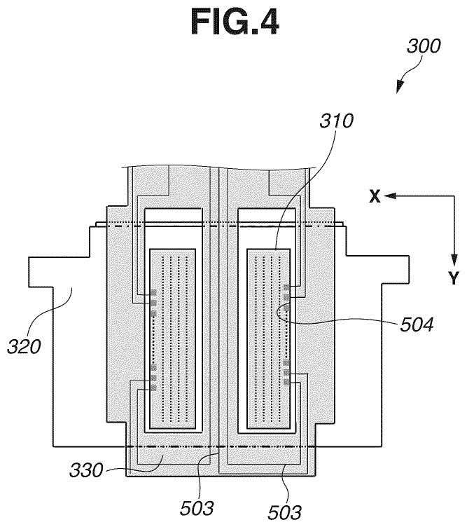

FIG. 4 is a schematic view illustrating the ejection unit 300 as viewed from the ejection openings included in the element substrates 310. In FIG. 4, the cover member 340 is not illustrated for the purpose of describing wiring (conductive wires) 503 on the flexible circuit board 330. The element substrates 310 include a plurality of connection terminals 504 electrically connected to the ejection elements along a long side of the element substrates 310. The connection terminals 504 are electrically connected to the wiring 503. In FIG. 4 and the schematic views of the ejection unit 300 illustrated in the subsequent drawings, the wiring 503 and the connection terminals 504 are partially illustrated. While the connection terminals 504 are disposed on one side of the long sides of each of the element substrates 310 in FIG. 4, the connection terminals 504 may be disposed on both of the long sides of each of the element substrates 310. A plurality of connection terminals 504 may be disposed along a short side of each of the element substrates 310. In the present exemplary embodiment, the element substrates 310 and the flexible circuit board 330 are electrically connected to each other by wire bonding. More specifically, the connection terminals 504 of the element substrates 310 and the wiring 503 of the flexible circuit board 330 are electrically connected by wire bonding. The electric connection may be made by other methods, such as flying lead bonding.

The wiring 503 is routed to connect to the electric circuit board 210 in the flexible circuit board 330. The flexible circuit board 330 is bonded to an upper surface (an XY plane in FIG. 4) of the support member 320, and portions of the flexible circuit board 330 protruding from the upper surface of the support member 320 are bent along the side surfaces of the support member 320.

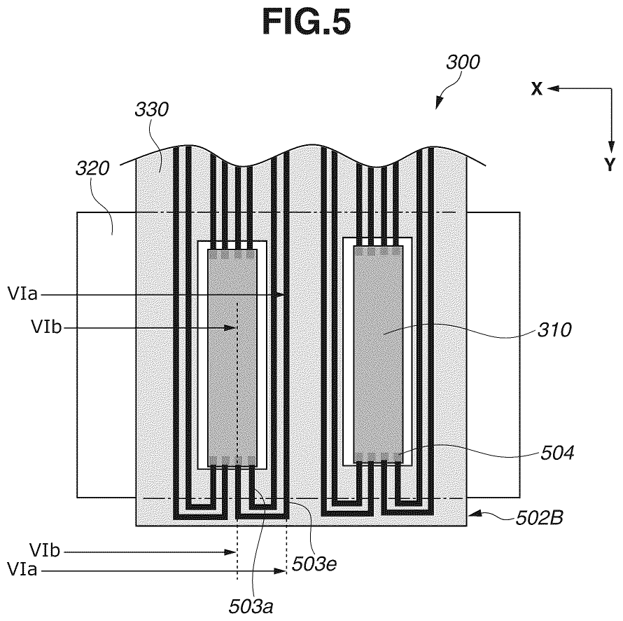

An issue that is addressed by the present disclosure will be described using a comparative example illustrated in FIG. 5. FIG. 5 is a schematic view illustrating the ejection unit 300 of the comparative example and illustrates a state before the flexible circuit board 330 is bent, the state in which the element substrates 310 and the flexible circuit board 330 have been bonded on the support member 320. In FIG. 5, similarly to FIG. 4, the cover member 340 is not illustrated, and the electric connection portion between the connection terminals 504 and the wiring 503 is illustrated in a simplified manner. In the comparative example illustrated in FIG. 5, a plurality of the connection terminals 504 is disposed along the short side of each of the element substrates 310. In this case, in a case where the wiring 503 is drawn out from the connection terminals 504 on the side with the connection member 200 toward the side with the electric circuit board 210, in the flexible circuit board 330, the wiring 503 may be formed in a pattern passing through the bending portion 502B due to the wiring layout (routing).

Depending on the positional relationship between the element substrates 310, the bending portion 502B, and the wiring 503, the flexibility of the flexible circuit board 330 and the wiring 503 inside the flexible circuit board 330 may vary among different portions. For example, the flexibility of the flexible circuit board 330 and wiring 503a at a portion facing a side of each of the element substrates 310 in the direction (Y direction) orthogonal to the direction (X direction) in which the bending portion 502A extends is often different from the flexibility of the flexible circuit board 330 and wiring 503e at a portion not facing the side of each of the element substrates 310 in the Y direction. A portion of the flexible circuit board 330 in a position where the element substrates 310 are absent in the same direction as the direction (Y direction) of bending the flexible circuit board 330, such as the wiring 503e, is able to be bent with a small load, and a bending portion with a small bend curvature in a stable shape is easily formed. On the other hand, in a portion of the flexible circuit board 330 in a position where the element substrates 310 are present in the same direction as the direction (Y direction) of bending the bending portion, such as the wiring 503a, a large load is to be applied in the bending, and reducing the bend curvature, keeping a stable position, and forming a stable shape are likely to be difficult.

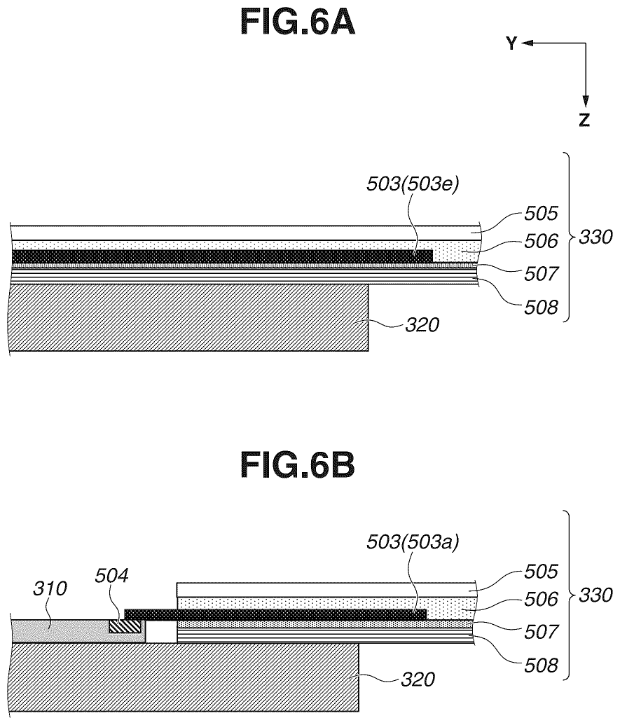

FIG. 6A is a cross-sectional view taken along a line VIa-VIa in FIG. 5, and FIG. 6B is a cross-sectional view taken along a line VIb-VIb in FIG. 5. As shown in FIGS. 6A and 6B, the flexible circuit board 330 has a configuration in which the wiring 503 is held between a cover film 505 and a base film 508. In the flexible circuit board 330, the wiring 503 and the cover film 505 are bonded to each other via a cover film adhesive 506, and the wiring 503 and the base film 508 are bonded to each other via a base film adhesive 507. In the present exemplary embodiment, as an example, the cover film 505 having a thickness of 4 micrometer (μm), the cover film adhesive 506 having a thickness of 40 μm, the wiring 503 having a thickness of 35 μm, the base film adhesive 507 having a thickness of 15 μm, and the base film 508 having a thickness of 50 μm are layered and bonded together. In the present exemplary embodiment, the wiring 503 is made of copper and is formed by etching a copper foil. The cover film 505 and the base film 508 are made of a polyimide. The cover film adhesive 506 and the base film adhesive 507 are cured and thus have a certain degree of hardness, but are softer than the wiring 503, the cover film 505, and the base film 508.

As illustrated in FIG. 6A, in a region where the flexible circuit board 330 is sufficiently long in the same direction as the bending direction (Y direction), each layer forming the flexible circuit board 330 is also long. Thus, in the bending of the flexible circuit board 330, the entire length is available for extension and contraction of each layer. On the other hand, in a region where the flexible circuit board 330 is short as illustrated in 6B, the absolute amount available for extension and contraction of each layer in deformation is small, and thus it is difficult to form a bend structure.

FIG. 7 is a cross-sectional view of a position of the line VIa-VIa in FIG. 5 and corresponds to the portion illustrated in FIG. 6A in a state where the flexible circuit board 330 has been bent. In a case where the bending portion 502B is large, the space 509 is also large, which increases the size (size in the Y direction) of the liquid ejection head 1. Further, the increase in the bending portion 502B on the side with the connection member 200 affects a position of a roller (not illustrated in FIG. 1A) for pressing the media P, which may affect the pressing width. These can be a factor leading to an increase in size of the entire liquid ejection apparatus.

Even with a reduced curvature of the bending portion 502B to reduce the bending portion 502B, there is still an issue that the wiring 503 inside the flexible circuit board 330 is easily broken at the bending portion having the small bend curvature.

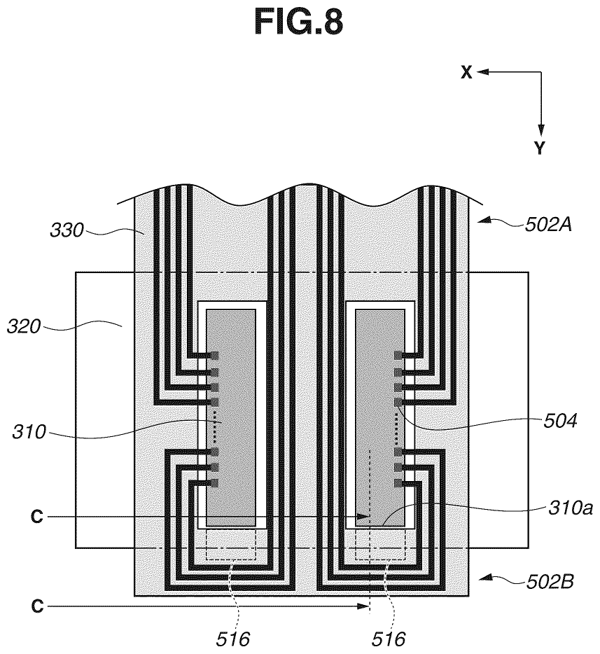

FIG. 8 is a schematic diagram illustrating the ejection unit 300 according to the first exemplary embodiment, and similarly to FIG. 5, illustrates a state before the flexible circuit board 330 is bent, the state in which the element substrates 310 and the flexible circuit board 330 have been bonded to the support member 320. In the present exemplary embodiment illustrated in FIG. 8, the two element substrates 310 and the one flexible circuit board 330 are disposed on the one support member 320. The connection terminals 504 are disposed along the one long side of each of the element substrates 310 bonded to the support member 320, and are electrically connected to the flexible circuit board 330 bonded on the support member 320. A terminal row in which the connection terminals 504 are disposed in one of the element substrates 310 is disposed along a side which does not face the other one of the element substrates 310. The flexible circuit board 330 includes the wiring 503 which passes through between the two element substrates 310.

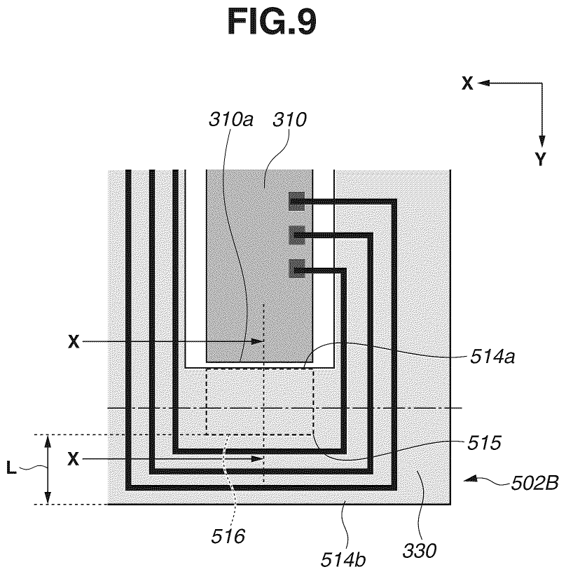

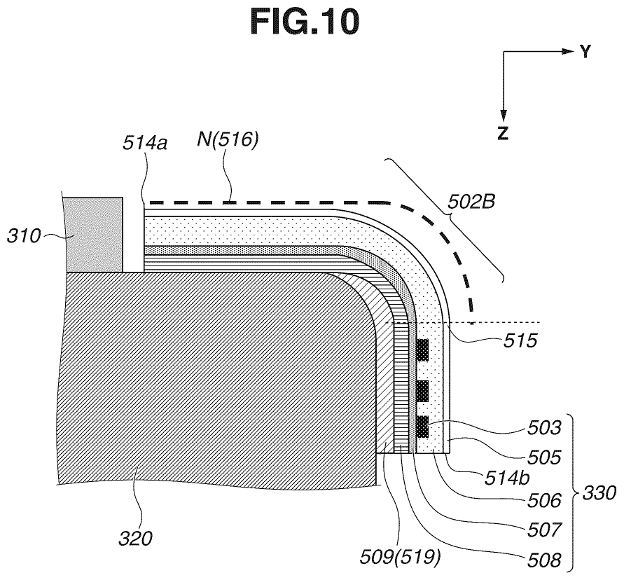

The portions of the flexible circuit board 330 protruding from the support member 320 are bent in a direction intersecting a direction in which the row of the plurality of connection terminals 504 extends, that is, in the Z direction along the Y direction in the present exemplary embodiment, whereby the connection to the electric circuit board 210 is formed. Further, in a region on the side with the connection member 200 which is the portion protruding from the support member 320 and is not to be connected to the electric circuit board 210, the flexible circuit board 330 is also bent in the direction (Y direction) intersecting the direction in which the terminal row extends. FIG. 9 is an enlarged view of a vicinity of the bending portion 502B in a vicinity of one of the element substrates 310 illustrated in FIG. 8. FIG. 10 is a cross-sectional view taken along a line X-X in FIG. 9. In the liquid ejection head 1 and the ejection unit 300 according to the present exemplary embodiment, the wiring 503 is disposed in such a manner that the bending portion 502B does not include the wiring 503 in a region 516 facing a side 310a of each of the element substrates 310, the region 516 being adjacent to each of the element substrates 310 in the bending direction (Y direction). In other words, when viewed in a direction perpendicular to the surface of the support member 320 supporting the element substrates 310, the bending portion 502B bent along a first direction (X direction) does not include the wiring 503 in the region 516 facing the side 310a of each of the element substrates 310 in the direction (second direction, Y direction) perpendicular to the first direction. In FIG. 9, the side 310a is a short side of the element substrates 310 (that is, a side on which the connection terminals 504 are absent). The adhesive (sealant) 519 is disposed in the space 509 between the support member 320 and the cover member 340.

A broken line N illustrated in FIG. 10 indicates the region 516 from a side of each of the element substrates 310 facing an end surface 514a of the flexible circuit board 330 to an end point (a position where the bending portion 502B no longer maintains its R shape) 515 of the bending portion 502B. In the present exemplary embodiment, the wiring 503 is disposed in such a manner that the wiring 503 avoids the region from the end surface 514a of the flexible circuit board 330, which faces the side 310a of each of the element substrates 310 in the Y direction, to the end point 515 of the bending portion 502B. With this configuration, in forming the bend shape, the flexible circuit board 330 is easily bent in a region where the length of the flexible circuit board 330 in the bending direction is short. In the present exemplary embodiment, as an example, the minimum width of the wiring 503 is set to 40 μm, and the minimum pitch is set to 80 μm. The size of the bending portion 502B of the flexible circuit board 330 is set to R=0.8 millimeter (mm), the length in the X direction of the region 516 which is the length of the side 310a of each of the element substrates 310 is set to 7 mm, and the length in the Y direction of the region 516 is set to 3 mm. A distance L from the region 516 to an end surface 514b (end surface) of the flexible circuit board 330 is 4 mm. On the side with electric circuit board 210, because a large portion of the flexible circuit board 330 is usable in the bending due to the configuration of the apparatus, the size of the bending portion 502A is set to R=2.0 mm. The size of a bending portion 502 (502A and/or 502B) may be evaluated by using not only the size of R but also the size of a portion protruding from the upper surface of the support member 320 in a direction parallel to the surface of the support member 320.

With the flexible circuit board 330 bent as described above and used in the liquid ejection head 1, good printing has been achieved for a long period of time. Even in an intermittent printing durability test (repetition of one hour printing and one hour standby) in a 5° C. environment, good printing has also been achieved.

Although not illustrated, the same effect has also been achieved even in a form in which the flexible circuit board 330 is bonded to the cover member 340, and in a form in which the flexible circuit board 330 is bonded to the support member 320, and on the product, the cover member 340 is bonded. The same effect has also been achieved in a form without the cover member 340.

The above-described effect is not limited to the configuration using the single-layer flexible circuit board in which the wiring 503 is formed in one layer as in FIGS. 6A and 6B, and is also applicable to a configuration using a flexible circuit board including a plurality of wires therein.

According to the present disclosure described above, the flexible circuit board is easily bent with a small curvature. This contributes to downsizing of the liquid ejection head and leads to downsizing of the liquid ejection apparatus itself. Further, the downsizing of the liquid ejection apparatus leads to reduction in apparatus manufacturing cost. The reduction in size of the bending portion of the flexible circuit board also leads to a reduction in the gap between the flexible circuit board and the support member, and the amount of adhesive (sealant) to be used to fill the gap is also reduced, which also leads to a reduction in manufacturing cost.

Further, the ability to easily bend the flexible circuit board reduces the load during the bending of the flexible circuit board, preventing decrease in reliability of the bending portion and the flexible circuit board. This also leads to improvement in reliability of the liquid ejection head.

A second exemplary embodiment will be described. Differences from the first exemplary embodiment described above will be mainly described, and the redundant descriptions of the similar parts to the configuration of the first exemplary embodiment will be omitted.

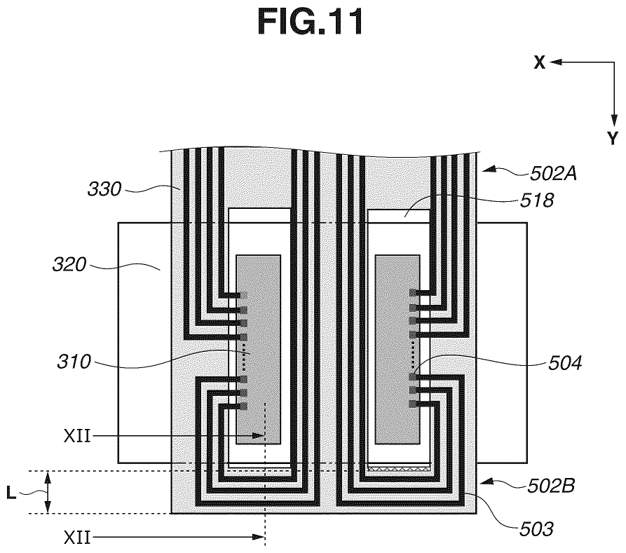

FIG. 11 is a schematic view illustrating an ejection unit 300 of the present exemplary embodiment, and similarly to FIG. 5, illustrates a state before a flexible circuit board 330 is bent, the state in which the element substrates 310 and the flexible circuit board 330 have been bonded to the support member 320. As in the first exemplary embodiment, the element substrates 310, which includes the connection terminals 504 on long sides thereof, and the flexible circuit board 330 are bonded to the surface of the support member 320.

In the present exemplary embodiment, openings 518 of the flexible circuit board 330 through which the element substrates 310 are exposed are enlarged to the bending portions. In other words, when viewed from the direction perpendicular to the surface of the support member 320, the openings 518 are configured to include the regions 516 facing the sides of the element substrates 310 in the direction orthogonal to the first direction. In FIG. 11, the openings 518 each include the entire part of the corresponding region 516. That is, parts of the flexible circuit board 330 are cut out to enclose the regions 516. In order to easily bend the flexible circuit board 330, it is desirable that the flexible circuit board 330 has a shape in which sides of the support member 320 are exposed as shown in FIG. 11. In the configuration of the present exemplary embodiment, since it is not necessary to bend a short length portion of the flexible circuit board 330, an effect is achieved that the flexible circuit board 330 is more easily bent than the flexible circuit board 330 having the configuration illustrated in FIG. 8. The openings 518 each enclosing the corresponding region 516 may be formed separately from the openings for exposing the element substrates 310 as illustrated in FIG. 8.

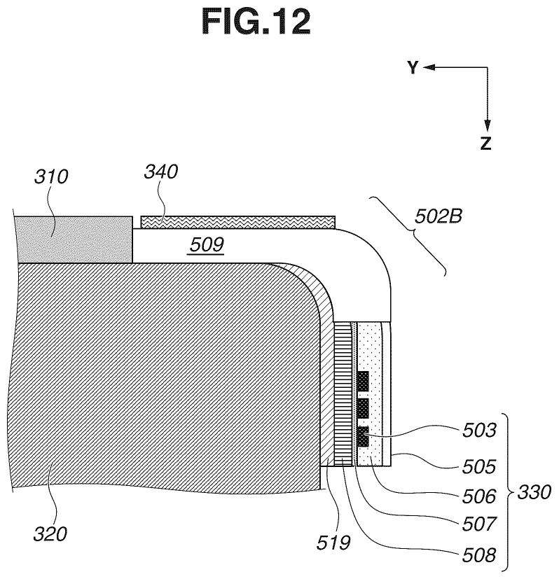

FIG. 12 is a cross-sectional view of a portion corresponding to the position of a line XII-XII illustrated in FIG. 11 in a state where the flexible circuit board 330 is bent. In FIG. 12, a cover member 340 is illustrated. In the region that is cut out from the flexible circuit board 330, a space 509 is formed between the support member 320 and the cover member 340, and is filled with the adhesive (sealant) 519 using a capillary action. Due to the presence of the cover member 340, a large amount of ink is unlikely to adhere to the space 509.

In the present embodiment, as an example, the minimum width of the wiring 503 is set to 40 μm, and the minimum pitch is set to 90 μm. The size of the bending portion 502B of the flexible circuit board 330 is set to R=0.8 mm, the length of the region 516 in the X direction which is the length of the side 310a of each of the element substrates 310 is set to 7 mm, and in the region 516, a part of the flexible circuit board 330 is cut out in the Y direction by 2.5 mm, leaving 0.5 mm. A distance L from the region 516 to an end of the flexible circuit board 330 is set to 4.0 mm.

On the side with electric circuit board 210, the parts of the flexible circuit board 330 in the region 516 are cut out since the ink is unlikely to adhere due to the configuration of the apparatus. With the liquid ejection head 1 configured with the ejection unit 300 having the above-described configuration, good printing has been achieved for a long period of time. Even in an intermittent printing durability test (printing for one hour and then standby for one hour) in a 5° C. (degree Celsius) environment, good printing has also been achieved.

A third exemplary embodiment will be described. Hereinafter, differences from the first and second exemplary embodiments described above will be mainly described, and the redundant descriptions of similar parts will be omitted.

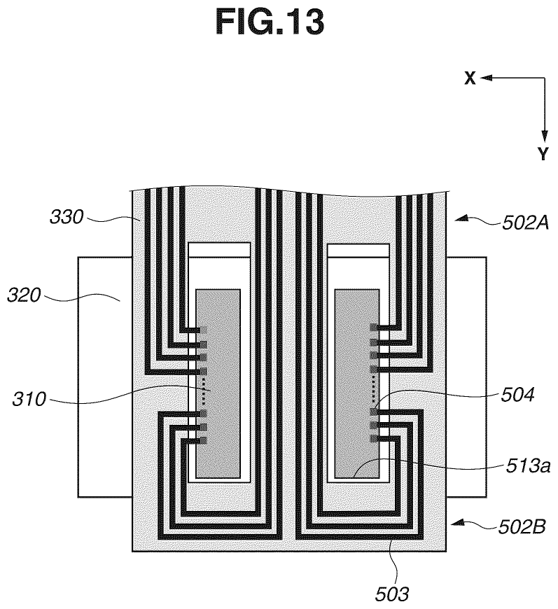

FIG. 13 is a schematic view illustrating an ejection unit 300 according to the present exemplary embodiment, and similarly to FIG. 5, illustrates a state before a flexible circuit board 330 is bent, the state in which the element substrates 310 and the flexible circuit board 330 have been bonded on the support member 320. As in the first exemplary embodiment, the element substrates 310, which include the connection terminals 504 on long sides thereof, and the flexible circuit board 330 are bonded to the surface of the support member 320.

In the present exemplary embodiment, the flexible circuit board 330 has the bending portion 502A having a shape similar to the shape in the first exemplary embodiment and the bending portion 502B having a shape similar to the shape in the second exemplary embodiment.

While an outer surface of the cover film 505 and an outer surface of the base film 508 of the flexible circuit board 330 have high ink resistance, surfaces of the layers via the adhesive layer are easily eroded by ink. Thus, it is desirable that an end surface (end portion) of the flexible circuit board 330 which faces a corresponding one of the element substrates 310 be protected by the sealant (adhesive) 519. On the other hand, if the protected portion of the end surface of the flexible circuit board 330 is large, it is likely to lead to deterioration of the lead time of the manufacturing process and increase in cost.

The present exemplary embodiment illustrated in FIG. 13 addresses the above-described issue, and the flexible circuit board 330 on the side with the connection member 200 employs the shape according to the first exemplary embodiment, and the flexible circuit board 330 on the side with the electric circuit board 210 employs the shape according to the second exemplary embodiment.

In the bending portion 502B on the side with the connection member 200, ink from one of the ink supply openings 201 is likely to adhere, and thus it is desirable to seal the space 509. Thus, in order to reduce the volume of the space 509 and reduce the amount of the adhesive (sealant) 519 to be filled, the area where the flexible circuit board 330 overlaps the support member 320 is not reduced as in the first exemplary embodiment, and the wiring 503 is disposed in such a manner that the wiring 503 avoids the regions 516. Because the ink resistance of the flexible circuit board 330 is higher than that of the adhesive (sealant) 519, the ink resistance reliability of the liquid ejection head is maintained.

On the other hand, in the bending portion 502A on the side with the electric circuit board 210, ink is less likely to adhere in comparison with the side with the connection member 200, due to the configuration of the liquid ejection apparatus 50, and thus a minimum filling of the adhesive (sealant) 519 is sufficient. Thus, as in the second exemplary embodiment, parts of the flexible circuit board 330 are cut out to prioritize the ease of bending.

With the liquid ejection head 1 configured with the ejection unit 300 having the above-described configuration, good printing has been achieved for a long period of time. In an intermittent printing durability test (printing for one hour and then standby for one hour) in a 5° C. environment, good printing has also been achieved.

A fourth exemplary embodiment will be described. Hereinafter, differences from the above-described exemplary embodiments will be mainly described, and the redundant descriptions of similar parts to the configurations of the above-described exemplary embodiments will be omitted.

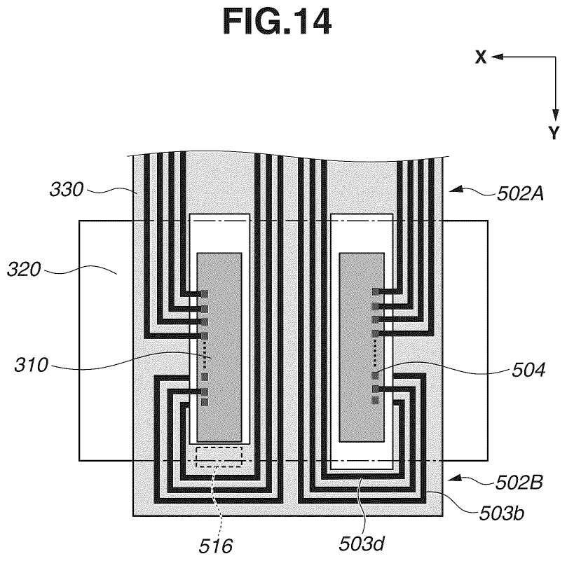

FIG. 14 is a schematic view illustrating the ejection unit 300 according to the present exemplary embodiment of the present disclosure, and similarly to FIG. 5, illustrates a state before a flexible circuit board 330 is bent, the state in which the element substrates 310 and the flexible circuit board 330 have been bonded to the support member 320.

In the configuration illustrated in FIG. 14, among the plurality of wires of the wiring 503 included in the flexible circuit board 330, the wiring 503b closest to the end portion on the outer perimeter of the flexible circuit board 330 and the wiring 503d adjacent to the end portion of an opening are dummy wiring which are not connected to the connection terminals 504. This configuration prevents decrease in reliability due to ink intrusion from the end of the flexible circuit board 330. The wiring 503d or the wiring 503b may be the dummy wiring. Both the wiring 503d and the wiring 503b may be the dummy wiring. While FIG. 14 illustrates a configuration in which the bending portion 502B on the side with the connection member 200 includes the dummy wiring, the bending portion 502A on the side with the electric circuit board 210 may include the dummy wiring, or both the bending portion 502A and the bending portion 502B may include the dummy wiring.

Ground wiring may be disposed instead of the dummy wiring, which produces a similar effect of preventing decrease in reliability due to ink intrusion from the end portion of the flexible circuit board 330. This is because no potential is applied to the ground wiring, and thus migration does not occur from the end portion.

The present exemplary embodiment may be a configuration in which the wiring 503 is absent in the region 516 of the flexible circuit board 330, as the bending portion 502B corresponding to the element substrate 310 illustrated in the left hand side of FIG. 14, or a configuration in which the flexible circuit board 330 has an opening including the region 516, as the bending portion 502B corresponding to the element substrate 310 illustrated in the right hand side of FIG. 14.

A fifth exemplary embodiment will be described. Hereinafter, differences from the above-described exemplary embodiments will be mainly described, and the descriptions of similar parts as the configurations of the above-described exemplary embodiments will be omitted.

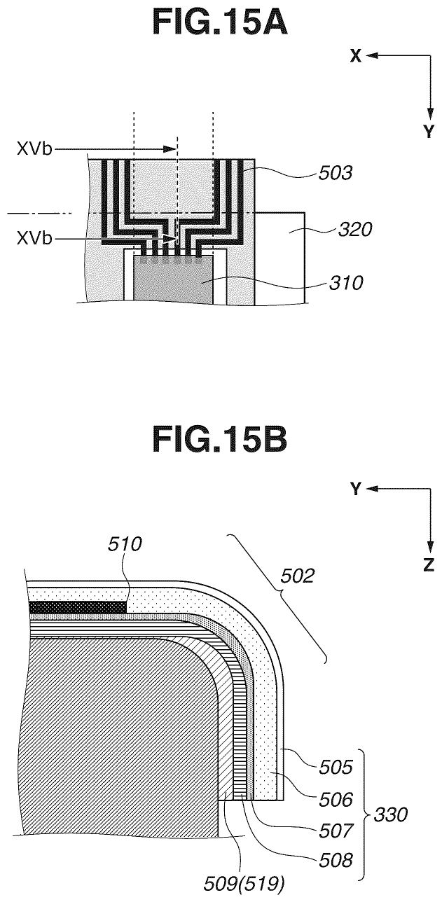

FIG. 15A is a partial schematic view illustrating the ejection unit 300 according to the present exemplary embodiment of the present disclosure and is an enlarged view of the bending portion 502A. Similarly to FIG. 5, FIG. 15A illustrates a state before a flexible circuit board 330 is bent, the state in which the element substrates 310 and the flexible circuit board 330 have been bonded on the support member 320. Unlike the first to fourth exemplary embodiments, in a configuration of the present exemplary embodiment, the element substrates 310 include the connection terminals 504 on short sides thereof. In this configuration, as in the comparative example illustrated in FIG. 5, with the wiring 503 disposed in a region facing the element substrates 310 in the bending direction (Y direction) of the bending portion 502A, forming the bending portion 502A tends to be difficult.

Thus, in the present exemplary embodiment, in routing of the wiring 503 toward the side with the electric circuit board 210, the wiring 503 is disposed in the direction (X direction) in which the bending portion 502A extends up to a region not facing the element substrates 310 in the Y direction, and is then extended in the direction (Y direction) of bending the bending portion 502A toward the side with the electric circuit board 210. FIG. 15B is a cross-sectional view taken along a line XVb-XVb illustrated in FIG. 15A. As illustrated in FIG. 15B, the wiring (copper foil) 503, which has a great influence on ease of the bending of the flexible circuit board 330, is not bent in the region facing the element substrates 310 in the Y direction, so that the bending portion 502A is formed with a small load.

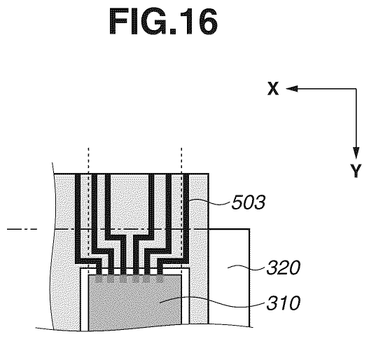

On the other hand, as in another comparative example illustrated in FIG. 16, in a case with the wiring 503 disposed in such a manner that the wiring 503 is bent in the Y direction without extending the wiring 503 in the X direction up to the region which does not face the element substrates 310, bending of the bending portion 502B with a small load is difficult, which leads to difficulty in forming a stable bend shape.

In the configuration of the present exemplary embodiment illustrated in FIGS. 15A and 15B, the wiring 503 is disposed along the bending portion 502A (in the X direction), and thus, in bending of the flexible circuit board 330, the flexible circuit board 330 acts to be bent from an edge 510 of the wiring 503 in the bending direction (Y direction), which may lead to difficulty in stably forming the bend shape and position.

Further, if the edge 510 is intentionally disposed in a position close to the bending portion 502B to form a bend shape starting from the edge 510, the edge 510 may bite into the cover film adhesive 506 like a blade to cause a crack in a portion of the flexible circuit board 330 to which tension is applied, and the cover film 505 may be damaged or cracked. Even in a case where the wiring 503 is disposed along the bending portion 502B as in the configuration illustrated in FIG. 9, as long as the edge 510 is disposed in the region closer to the end of the flexible circuit board 330 than the bending portion 502B, not in the region adjacent to the short side of the corresponding element substrate 310, the flexible circuit board 330 has a sufficient length available for extension and contraction, and therefore, cracks starting from the edge 510 of the wiring 503 is unlikely to occur.

A sixth exemplary embodiment will be described. Hereinafter, differences from the above-described exemplary embodiments will be mainly described, and the redundant descriptions of similar parts to the configurations of the above-described exemplary embodiments will be omitted.

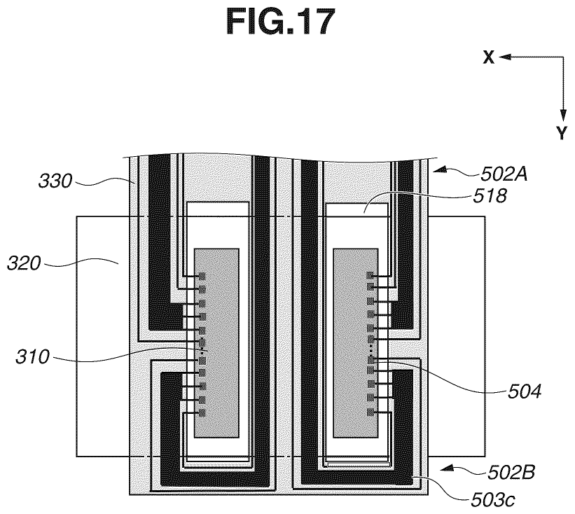

In the first to fifth exemplary embodiments described above, one wire 503 is connected to one connection terminal 504, and each wire 503 is routed toward the side with electric circuit board 210. The configuration of the connection terminals 504 and the wiring 503 of the present disclosure is not limited thereto, and the present disclosure is suitably applicable even to a configuration in which a plurality of wires 503 is combined in the flexible circuit board 330, for example. FIG. 17 is a partial schematic view illustrating the ejection unit 300 according to the present exemplary embodiment of the present disclosure. The configuration illustrated in FIG. 17 has wiring 503c in which a plurality of wires connected to the plurality of connection terminals 504 is combined.

In the present exemplary embodiment, a voltage of 24 volt (V) is applied as a driving voltage of the ejection elements, but the wire resistance is reduced by using the wiring 503c in which a plurality of wires is combined. On the other hand, with the wiring 503c in which the plurality of wires is combined disposed, the flexibility of the flexible circuit board 330 may be reduced.

Therefore, in the case of the configuration in which a plurality of wires is combined, it is desirable to employ a configuration in which wires for power supply are combined and wires for drive signals of the ejection element are not combined.

According to the present disclosure, a liquid ejection head in which electrical reliability of wiring in a bending portion of a flexible circuit board is improved is obtained.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-038809, filed Mar. 13, 2024, which is hereby incorporated by reference herein in its entirety.

What is claimed is:

1. A liquid ejection head comprising:
an element substrate configured to include an element, which is driven by a drive signal, and an ejection opening for ejecting liquid by driving of the element;
a flexible circuit board configured to include wiring for supplying the drive signal to the element; and
a support member configured to support the element substrate and the flexible circuit board via a surface of the support member,
wherein the flexible circuit board has a bending portion bent along one side of the support member extending in a first direction, and
wherein in the bending portion, the wiring is absent in a region facing a side of the element substrate in a second direction orthogonal to the first direction when viewed from a direction perpendicular to the surface of the support member.

2. The liquid ejection head according to claim 1, further comprising
a housing configured to support the support member; and
an electric circuit board disposed on a first side surface of the housing in the second direction and configured to be electrically connected to the flexible circuit board.

3. The liquid ejection head according to claim 2,
wherein the element substrate includes a plurality of terminals for electric connection to the wiring, and
wherein the plurality of terminals is disposed in a row in a direction intersecting the first direction.

4. The liquid ejection head according to claim 3,
wherein the wiring includes:
first wiring extending from a connection portion with the plurality of terminals to the electric circuit board; and
second wiring extending from a connection portion with the plurality of terminals toward a side opposite to the electric circuit board and then extending toward the electric circuit board.

5. The liquid ejection head according to claim 1, wherein the flexible circuit board has an opening in which the element substrate is disposed.

6. The liquid ejection head according to claim 2, wherein the bending portion is on a side with the electric circuit board in the second direction.

7. The liquid ejection head according to claim 2, wherein the bending portion is on a side opposite to a side with the electric circuit board in the second direction.

8. The liquid ejection head according to claim 2, wherein the bending portion is on both sides of the support member in the second direction.

9. The liquid ejection head according to claim 1, wherein the element substrate includes the ejection opening and a terminal for electric connection to the wiring on a surface opposite to a surface facing the surface of the support member.

10. The liquid ejection head according to claim 1, further comprising a resin member between the flexible circuit board and a side surface of the support member intersecting the surface of the support member.

11. The liquid ejection head according to claim 3, further comprising dummy wiring or ground wiring disposed corresponding to a terminal disposed at an end of the plurality of terminals.

12. The liquid ejection head according to claim 1, further comprising a cover member disposed on a surface of the flexible circuit board opposite to the support member.

13. The liquid ejection head according to claim 1,
wherein the element substrate includes a first element substrate and a second element substrate disposed side by side in the first direction, and
wherein the element substrate includes the wiring disposed in such a manner that the wiring passes between the first element substrate and the second element substrate.

14. The liquid ejection head according to claim 13,
wherein the first element substrate includes a terminal array in which a plurality of terminals for electric connection to the wiring is disposed in a direction intersecting the first direction, and
wherein the terminal array is disposed along a side of the first element substrate which does not face the second element substrate.

15. A liquid ejection head comprising:
an element substrate configured to include an element, which is driven by a drive signal, an ejection opening for ejecting liquid by driving of the element, and a terminal for receiving the drive signal externally;
a flexible circuit board configured to include wiring for supplying the drive signal to the element; and
a support member configured to support the element substrate and the flexible circuit board via a surface of the support member,
wherein the flexible circuit board has a bending portion bent along one end of the support member extending in a first direction, and
wherein the bending portion has an opening including a region facing a side of the element substrate in a second direction orthogonal to the first direction when viewed from a direction perpendicular to the surface of the support member.

16. A liquid ejection apparatus comprising:
a liquid ejection head including
an element substrate configured to include an element, which is driven by a drive signal, and an ejection opening for ejecting liquid by driving of the element;
a flexible circuit board configured to include wiring for supplying the drive signal to the element; and
a support member configured to support the element substrate and the flexible circuit board via a surface of the support member,
wherein the flexible circuit board has a bending portion bent along one side of the support member extending in a first direction,
wherein in the bending portion, the wiring is absent in a region facing a side of the element substrate in a second direction orthogonal to the first direction when viewed from a direction perpendicular to the surface of the support member, and
wherein the liquid ejection head is configured to perform scanning motion.
